(19) United States
(12) Patent Application Publication
(10) Pub. No.: US 2025/0346319 A1
(43) Pub. Date: Nov. 13, 2025

(54) PARTS BOX

(71) Applicant: SUZUKI MOTOR CORPORATION, Hamamatsu-shi (JP)

(72) Inventor: Taku SHIOSAKA, Hamamatsu-shi (JP)

(73) Assignee: SUZUKI MOTOR CORPORATION, Hamamatsu-shi (JP)

(21) Appl. No.: 19/087,134

(22) Filed: Mar. 21, 2025

(30) Foreign Application Priority Data
May 8, 2024 (JP) 2024-076010

(51) Int. Cl. B62J 43/28; B62J 43/30; B62J 45/00

(52) U.S. Cl. CPC B62J 43/28; B62J 43/30; B62J 45/00

(57) ABSTRACT

A parts box includes: a parts holder having a storage space opened on an outer side in a vehicle width direction; a vehicle body cover configured to cover an opening of the storage space from the outer side in the vehicle width direction; and a separator configured to partition the storage space into an inner side and the outer side in the vehicle width direction. The separator includes: a battery holding portion configured to hold a battery; and a parts holding portion including a first side surface and a second side surface opposite to the first side surface in the vehicle width direction and configured to hold electrical components. The electrical components include a first electrical component held on the first side surface and a second electrical component held on the second side surface.

### CROSS-REFERENCE TO RELATED APPLICATIONS

This application is based on and claims priority under 35 USC 119 from Japanese Patent Application No. 2024-076010 filed on May 8, 2024, the contents of which are incorporated herein by reference.

### TECHNICAL FIELD

The present disclosure relates to a parts box.

### BACKGROUND ART

For example, JP2011-073468A describes a straddle-type vehicle in which a parts box for an electrical component is formed in the vicinity of a rear fender at a rear side of the vehicle. In the straddle-type vehicle, a side edge portion on a left side of a rear fender in a vehicle width direction extends downward, and a support surface for an electrical component is formed on an extending portion of the rear fender. The support surface of the rear fender is covered with a side cover from the left side in the vehicle width direction, and a peripheral wall protrudes from the side cover along an outer edge of the support surface. The peripheral wall contacts the outer edge of the support surface of the rear fender from the side cover, whereby a storage space of the electrical component.

### SUMMARY OF INVENTION

In recent years, there is a need to mount, in addition to an electrical component, various components on a straddle-type vehicle, which may result in increase of restrictions on the layout of the components. If a plurality of electrical components are brought into the parts box described in JP2011-073468A, the parts box becomes large and the appearance of the vehicle deteriorates.

The present disclosure has been made in view of the above circumstances, and an object thereof is to provide a parts box capable of compactly storing a plurality of electrical components, thereby reducing the size of the parts box and suppressing deterioration of an appearance of a vehicle.

An aspect of the present disclosure provides a parts box of a straddle-type vehicle configured to store a battery and a plurality of electrical components, the parts box including: a parts holder having a storage space opened on an outer side in a vehicle width direction; a vehicle body cover configured to cover an opening of the storage space from the outer side in the vehicle width direction; and a separator configured to partition the storage space into an inner side and the outer side in the vehicle width direction, in which: the separator includes: a battery holding portion configured to hold the battery; and a parts holding portion including a first side surface and a second side surface opposite to the first side surface in the vehicle width direction, the parts holding portion being configured to hold the plurality of electrical components; and the plurality of electrical components include a first electrical component held on the first side surface of the parts holding portion and a second electrical component held on the second side surface of the parts holding portion.

With the parts box according to an aspect of the present disclosure, the separator is divided into the battery holding portion and the parts holding portion to hold the battery and the plurality of electrical components, and the battery and the plurality of electrical components are separately stored at an inner side and an outer side of the storage space of the parts box. Therefore, the battery and the plurality of electrical components are compactly stored in the parts box, so that the parts box can be reduced in size and deterioration of the appearance of the vehicle can be suppressed.

### BRIEF DESCRIPTION OF DRAWINGS

The present disclosure will be described in detail based on the following without being limited thereto, wherein:

FIG. 1 is a left side view of a straddle-type vehicle according to the present embodiment;

FIG. 2 is a left side view of a parts box according to the present embodiment;

FIG. 3 is a left side view of an inner side of the parts box according to the present embodiment;

FIG. 4 is a perspective view of the inner side of the parts box according to the present embodiment as viewed from a diagonally left front side;

FIG. 5 is a perspective view of the inner side of the parts box according to the present embodiment as viewed from a diagonally left rear side;

FIG. 6 is a sectional view of the parts box in FIG. 2 taken along a line A-A;

FIG. 7 is a sectional view of the parts box in FIG. 2 taken along a line B-B;

FIG. 8 is a sectional view of the parts box in FIG. 2 taken along a line C-C;

FIG. 9 is a sectional view of the parts box in FIG. 3 taken along a line D-D; and

FIG. 10 is a sectional view of the parts box in FIG. 3 taken along a line E-E.

### DESCRIPTION OF EMBODIMENTS

A parts box according to an aspect of the present disclosure may store a battery and a plurality of electrical components. In the parts box, a parts holder is covered with a vehicle body cover, a storage space of the parts holder is opened on an outer side in a vehicle width direction, and an opening of the storage space is covered with the vehicle body cover from the outer side in the vehicle width direction. The storage space is partitioned into an inner side and the outer side in the vehicle width direction by the separator, the battery is held by a battery holding portion of a separator, the battery holding portion includes a first side surface and a second side surface opposite to the first side surface in the vehicle width direction, and the plurality of electrical components include a first electrical component held on the first side surface of the parts holding portion and a second electrical component held on the second side surface of the parts holding portion of the separator. The separator is divided into the battery holding portion and the parts holding portion to hold the battery and the plurality of electrical components, and the battery and the plurality of electrical components are separately stored at the inner side and the outer side of the storage space of the parts box. Therefore, the battery and the plurality of electrical components are compactly stored in the parts box, so that the parts box can be reduced in size and deterioration of the appearance of the vehicle can be suppressed.

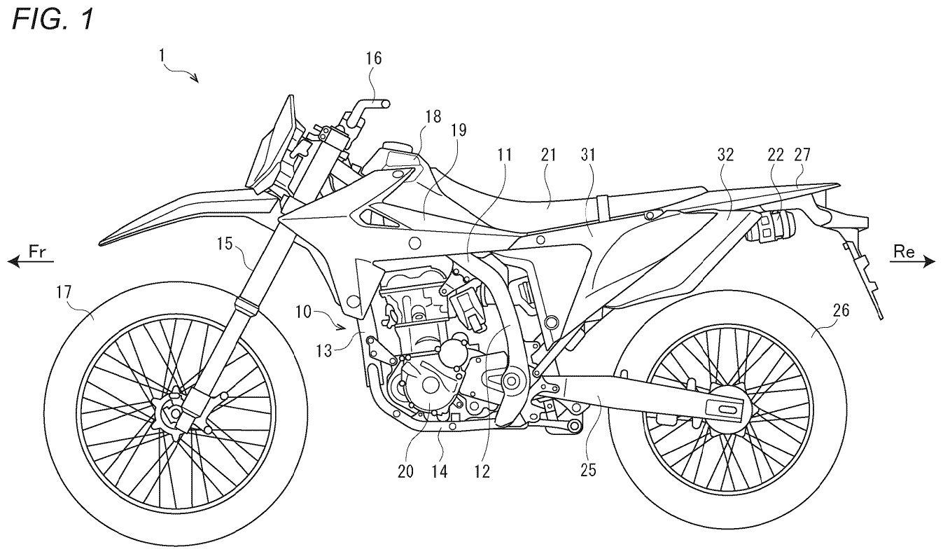

Hereinafter, a straddle-type vehicle including a parts box according to the present embodiment will be described with reference to the accompanying drawings. FIG. 1 is a left side view of the straddle-type vehicle according to the present embodiment. In the following drawings, an arrow Fr indicates a vehicle front side, an arrow Re indicates a vehicle rear side, an arrow L indicates a vehicle left side, and an arrow R indicates a vehicle right side.

As illustrated in FIG. 1, a straddle-type vehicle 1 is implemented by mounting various components such as an engine 20 and an electrical system on a vehicle body frame 10. A pair of main frames 11 extend diagonally rearward and downward from a head pipe (not illustrated) of the vehicle body frame 10. Rear portions of the pair of main frames 11 form a pair of body frames 12 bent downward. A down frame 13 extends downward from the head pipe, and an under loop 14 bent rearward is connected to a lower portion of the down frame 13. Rear ends of the pair of under loops 14 are connected to lower portions of the pair of body frames 12, so that the vehicle body frame 10 is formed into a cradle shape.

A front fork 15 is supported so as to be steered by the head pipe via a steering shaft (not illustrated). A handlebar 16 is provided on an upper portion of the front fork 15. A front wheel 17 is rotatably supported on a lower portion of the front fork 15. Upper portions of the pair of main frames 11 are covered with a fuel tank 18, and the main frames 11 and the fuel tank 18 are covered with a side cover 19 from a lateral side. A seat 21 is installed on the rear side of the fuel tank 18, and a frame cover (vehicle body cover) 31 and a parts cover (vehicle body cover) 32 are installed below the seat 21.

A canister 22 is exposed to the rear of the parts cover 32, and fuel vapor generated in the fuel tank 18 is adsorbed by the canister 22 and sent to the engine 20. The engine 20 is a four-stroke, single-cylinder engine, and is suspended inside the vehicle body frame 10 via a suspension bracket. A swing arm 25 is pivotally supported by the body frames 12. The swing arm 25 extends rearward from the body frame 12, and a rear wheel 26 is rotatably supported at a rear end of the swing arm 25. Power from the engine 20 is transmitted to the rear wheel 26 via a transmission mechanism (not illustrated).

A parts box that stores a battery and various electrical components is installed at a rear portion of the straddle-type vehicle, and when these components are simply integrated in the parts box, the parts box is increased in size. It is necessary to store a maintenance notebook, a manual, and the like in the parts box, and it is also necessary to secure a routing path of wiring such as a harness. Therefore, in the parts box according to the present embodiment, the inside of the parts box is divided into the inner side and the outer side in the vehicle width direction by a separator in consideration of a shape, a width dimension, and the like of each portion, and the portions are compactly stored using the space inside and outside the separator.

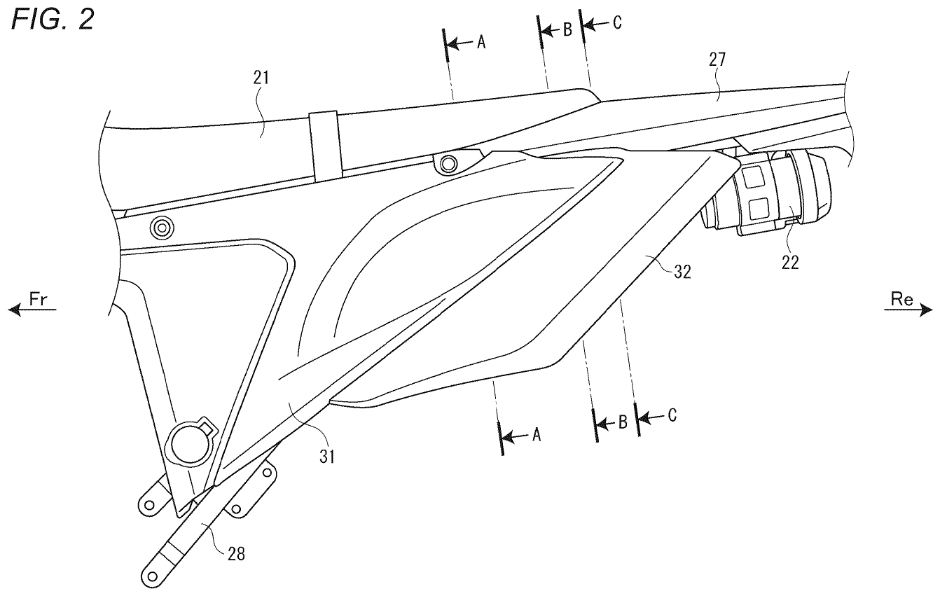

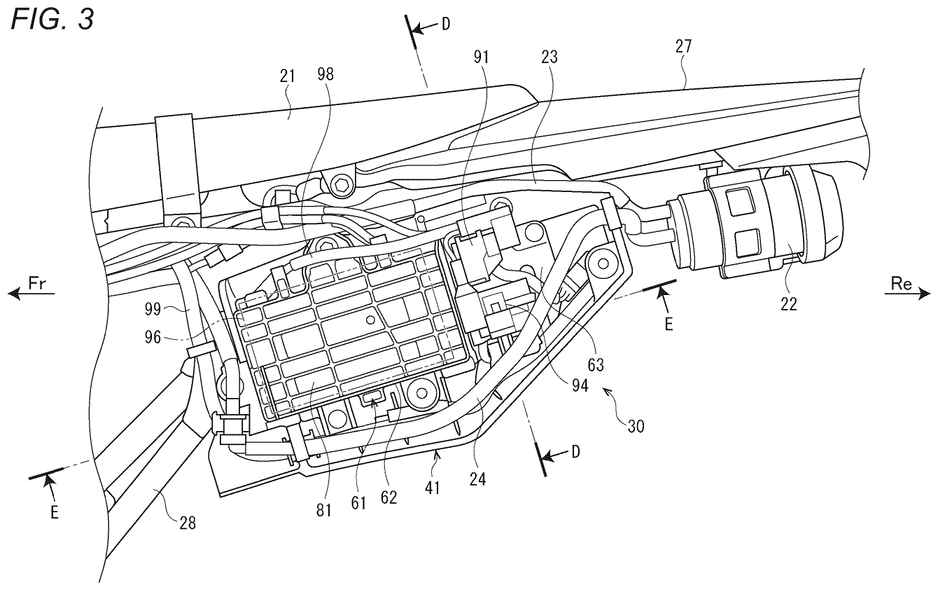

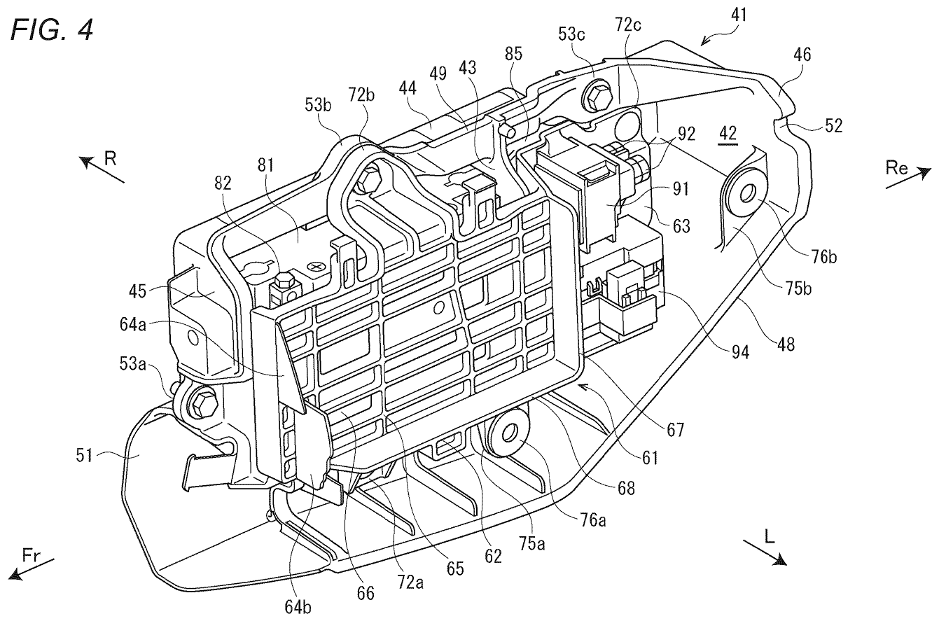

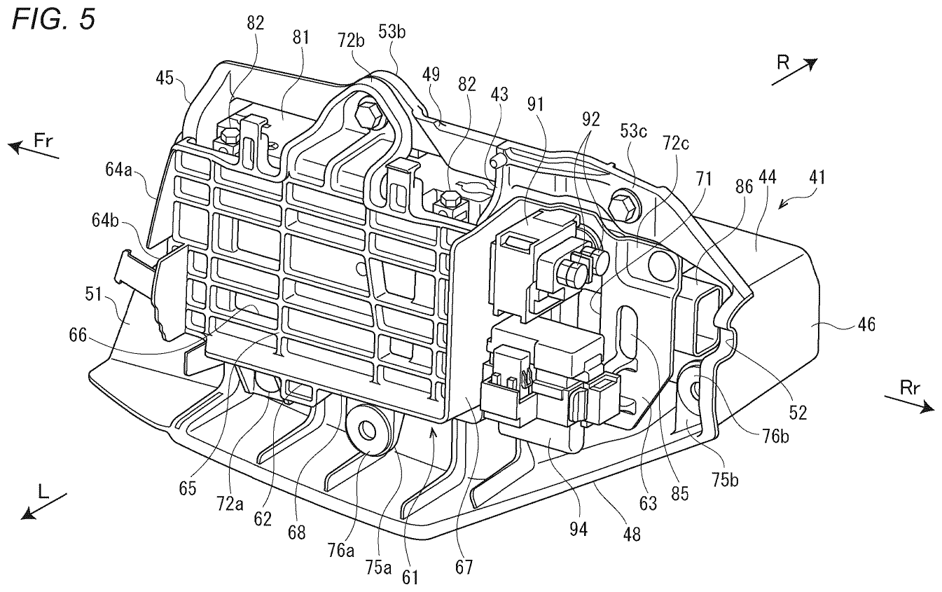

The parts box will be described with reference to FIGS. 2 to 5. FIG. 2 is a left side view of the parts box according to the present embodiment. FIG. 3 is a left side view of the inner side of the parts box according to the present embodiment. FIG. 4 is a perspective view of the inner side of the parts box according to the present embodiment as viewed from a diagonally left front side. FIG. 5 is a perspective view of the inner side of the parts box according to the present embodiment as viewed from a diagonally left rear side.

As illustrated in FIG. 2, a rear fender 27 is installed on the rear side of the seat 21, and an upper surface of a rear portion of the vehicle is formed by the seat 21 and the rear fender 27. The frame cover 31 and the parts cover 32 are installed below the seat 21 and the rear fender 27, and an outer side surface of the rear portion of the vehicle is formed by the frame cover 31 and the parts cover 32. A seat frame 28 at a rear side of the body frame 12 is covered with the frame cover 31 from the outer side in the vehicle width direction. The parts cover 32 is continuous to a rear edge of the frame cover 31. The canister 22 is supported below the rear fender 27 and on the rear side of the parts cover 32.

As illustrated in FIG. 3, the parts box 30 has a slim shape with a small left-right dimension, and is fixed to a left side portion of the seat frame 28 above the rear wheel 26 (see FIG. 1). A battery 81, a plurality of electrical components, and the like are stored in the parts box 30. An inner side surface (one side surface on inner side in vehicle width direction) of the parts box 30 is formed by a parts holder 41, and an outer side surface (other side surface on outer side in vehicle width direction) of the parts box 30 is formed by the frame cover 31 and the parts cover 32 (see FIG. 2). A storage space 42 opened on the outer side in the vehicle width direction is formed in the parts holder 41. The opening of the storage space 42 (see FIG. 4) is covered with the frame cover 31 and the parts cover 32 from the outer side in the vehicle width direction.

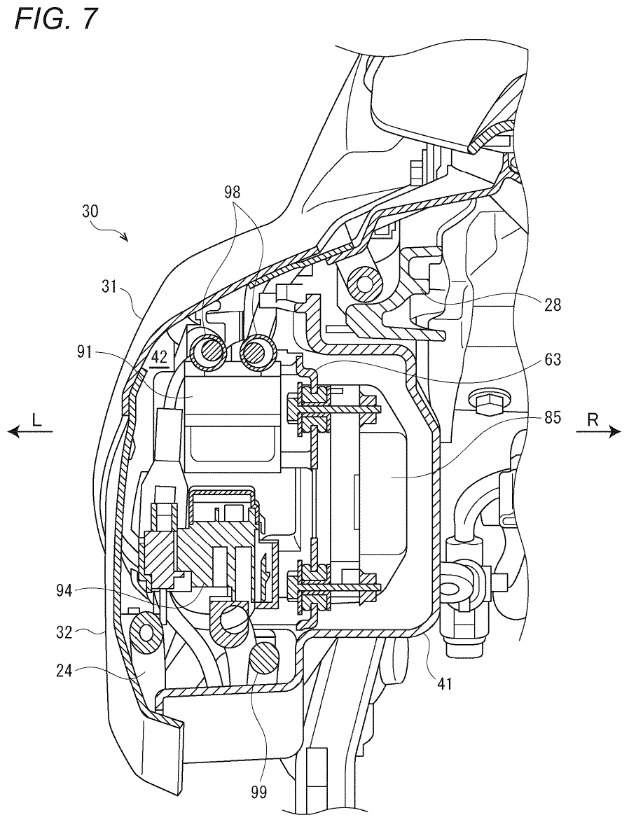

The storage space 42 of the parts box 30 is partitioned into the inner side and the outer side in the vehicle width direction by a separator 61. A front portion of the separator 61 is a battery holding portion 62, and a rear portion of the separator 61 is a parts holding portion 63. The battery 81 is held on an inner side surface of the battery holding portion 62, and a rectifier 85 (see FIG. 7), a starter motor relay 91, and a fuse box 94 are held as the plurality of electrical components on both side surfaces of the parts holding portion 63. A maintenance notebook (notebook) 96, lead wires 98, a main harness 99, a purge hose 24, and the like are stored in the storage space 42 of the parts box 30.

As illustrated in FIGS. 4 and 5, the parts holder 41 is formed in a box shape opened on the outer side (left side) in the vehicle width direction. The battery 81 having a rectangular shape in a side view is stored in a front half of an upper portion of the parts holder 41, and an inner side of the parts holder 41 is partitioned by a partition wall 43 to form a storage chamber for the battery 81. The plurality of electrical components are stored in a rear half of the upper portion of the parts holder 41, and a routing path of a cable, a hose, or the like is secured in a lower portion of the parts holder 41. An upper wall 44 of the parts holder 41 is further retracted to the inner side in the vehicle width direction, and a routing path of a cable or the like is also secured at the outer side of a wall portion 49 in the vehicle width direction. The wall portion 49 protrudes upward from a left side edge of the upper wall 44.

A lower side of a front wall 45 of the parts holder 41 is opened, and cables are routed inside the parts holder 41 through an opening 51 of the front wall 45. A rear wall 46 of the parts holder 41 is partially cut out, and the purge hose 24 (see FIG. 3) of the canister 22 extends to the outer side of the parts holder 41 through a notch 52 of the rear wall 46. The surge hose 23 (see FIG. 3) of the canister 22 extends rearward above the parts holder 41. A fixing portion 53a is provided on the front wall 45 of the parts holder 41, fixing portions 53b and 53c are provided on the wall portion 49 of the upper wall 44 of the parts holder 41, and the parts holder 41 is screwed to the seat frame 28 by the three fixing portions 53a to 53c.

The separator 61 is fixed to the parts holder 41, and the inside of the parts holder 41 is partitioned by the separator 61 in the vehicle width direction. The separator 61 is formed by connecting the battery holding portion 62 and the parts holding portion 63 in a crank shape in a top view. More specifically, the parts holding portion 63 is located on the rear side of the battery holding portion 62, and the parts holding portion 63 is located inward (battery 81 side) in the vehicle width direction with respect to the battery holding portion 62. Since the parts holding portion 63 is offset inward in the vehicle width direction with respect to the battery holding portion 62, the plurality of electrical components are compactly stored in a rear space of the battery 81, which is wide.

The battery holding portion 62 is formed in a rectangular shape in a side view, and the storage chamber for the battery 81 is covered with the battery holding portion 62 from the outer side in the vehicle width direction. The battery 81 is held on the inner side surface of the battery holding portion 62. A pair of battery terminals 82 are provided on an upper portion of the battery 81, and the pair of battery terminals 82 are exposed from between the upper wall 44 of the parts holder 41 and the battery holding portion 62. One battery terminal 82 is located on an upper front side of the battery 81, and the other battery terminal 82 is located on an upper rear side of the battery 81. A pair of lead wires 98 (see FIG. 3) are connected to the pair of battery terminals 82.

A pair of partition plates 64a and 64b protrude outward in the vehicle width direction from a front edge of the battery holding portion 62. The partition plate 64a is located at an upper half of the front edge of the battery holding portion 62 and extends in an upper-lower direction, and the partition plate 64b is located at a lower half of the front edge of the battery holding portion 62 and extends in the upper-lower direction. The partition plate 64b is located on the rear side of the partition plate 64a with a gap therebetween, and the partition plates 64a and 64b form a labyrinth structure that allows a driving wind to pass therethrough and prevents entry of a foreign matter such as mud. A grid-like rib 65 is formed on an outer side surface of the battery holding portion 62, and an opening 66 for exposing the battery 81 is formed between a part of the rib 65.

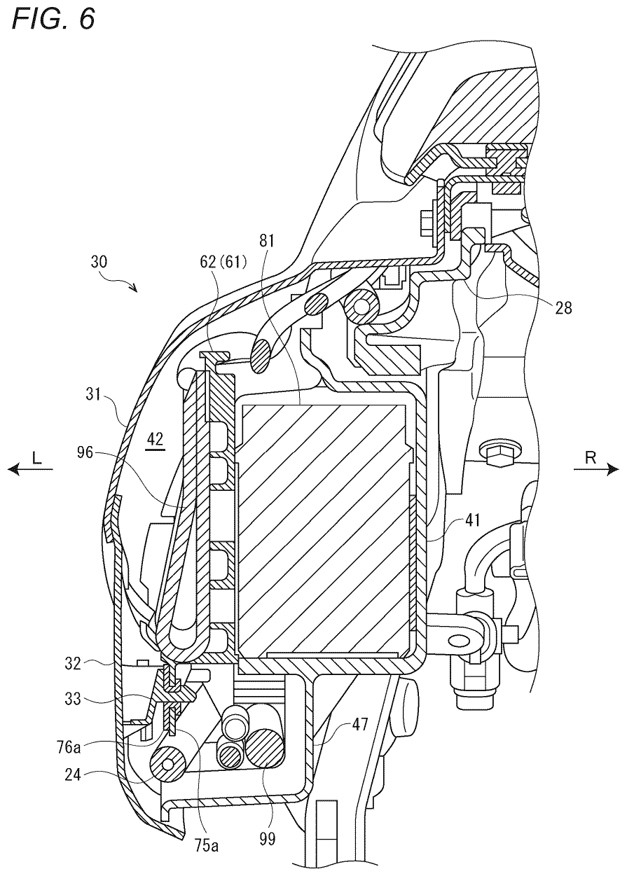

A rear plate 67 protrudes outward in the vehicle width direction from a rear edge of the battery holding portion 62, and a lower plate 68 protrudes outward in the vehicle width direction from a lower edge of the battery holding portion 62. A storage chamber for the maintenance notebook 96 (see FIG. 6) is formed on the outer side of the battery holding portion 62 in the vehicle width direction by the pair of partition plates 64a and 64b, the rear plate 67, and the lower plate 68. The rectifier 85 is held in a vertical orientation on an inner side surface of the parts holding portion 63. A connector 86 of the rectifier 85 is directed rearward, and the main harness 99 (see FIG. 3) continuous to an electrical component or the like of the vehicle body is connected to the connector 86.

The starter motor relay 91 and the fuse box 94 are vertically aligned and held on the outer side surface of the parts holding portion 63. The starter motor relay 91 is located at the upper side, and the fuse box 94 is located at the lower side. A pair of relay terminals 92 of the starter motor relay 91 are directed rearward, and the lead wires 98 extending from the pair of battery terminals 82 are connected to the pair of relay terminals 92. A pair of elongate holes 71 for exposing the rectifier 85 is formed in the center of the parts holding portion 63. A method of fixing each electrical component to the parts holding portion 63 will be described later.

A fixing portion 72a protrudes downward from the lower edge of the battery holding portion 62, and a fixing portion 72b extends inward in the vehicle width direction from an upper edge of the battery holding portion 62 through between the pair of battery terminals 82. A fixing portion 72c is provided at an upper rear side of the parts holding portion 63. The battery holding portion 62 and the parts holding portion 63 are screwed to the parts holder 41 by the fixing portions 72a and 72c, and the battery holding portion 62 and the parts holder 41 are screwed to the seat frame 28 by the fixing portion 72b. In this manner, the separator 61 is fixed to the parts holder 41 at two positions in the upper-lower direction of the battery 81 and one position on the rear side of the starter motor relay 91.

On the rear side of the fixing portion 72a of the battery holding portion 62, a fixing portion 75a protrudes downward from the lower edge of the battery holding portion 62, and a rubber bush 76a is mounted on the fixing portion 75a. A fixing portion 75b protrudes inward from a corner portion between the rear wall 46 and a lower wall 48 of the parts holder 41, and a rubber bush 76b is mounted on the fixing portion 75b. The parts cover 32 is inserted and fixed to the fixing portions 75a and 75b. In this manner, the parts cover 32 is fixed to the separator 61 (battery holding portion 62) at one position below the maintenance notebook 96, and the parts cover 32 is fixed to the parts holder 41 at one position on the rear side of the fuse box 94.

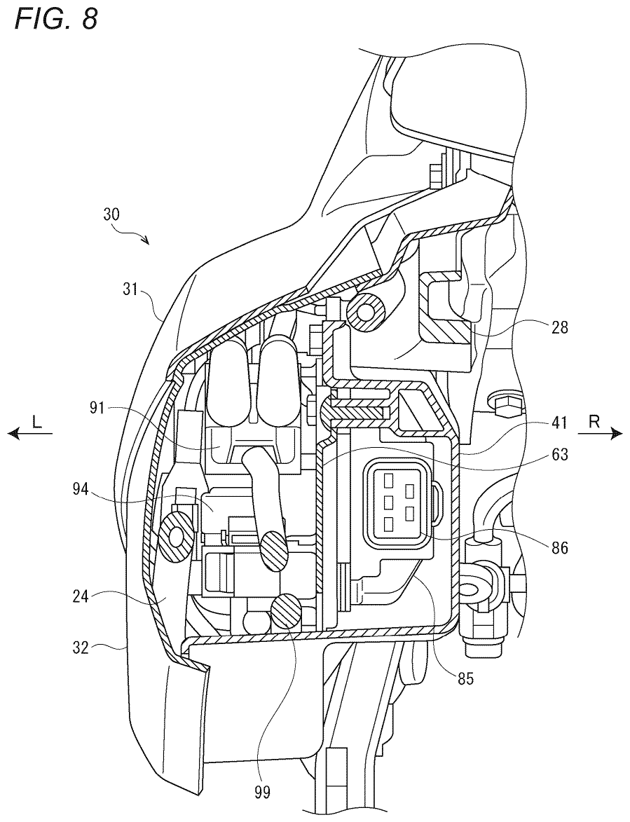

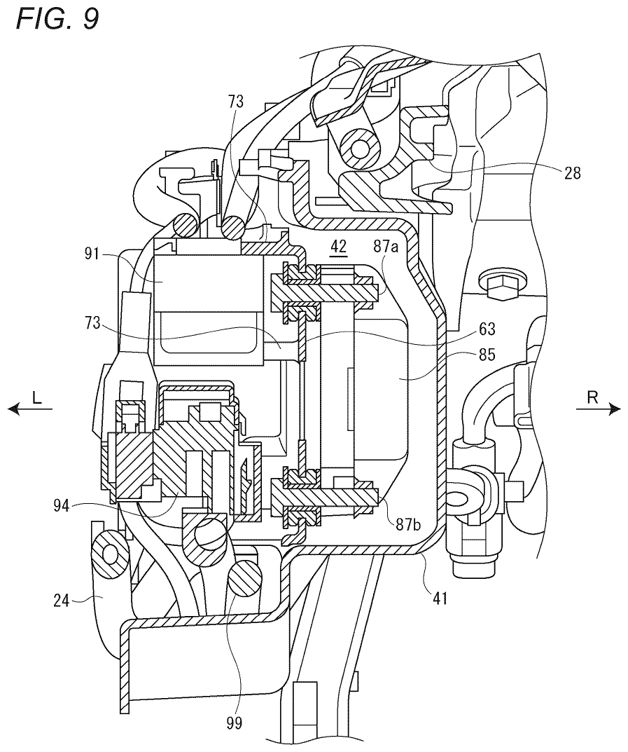

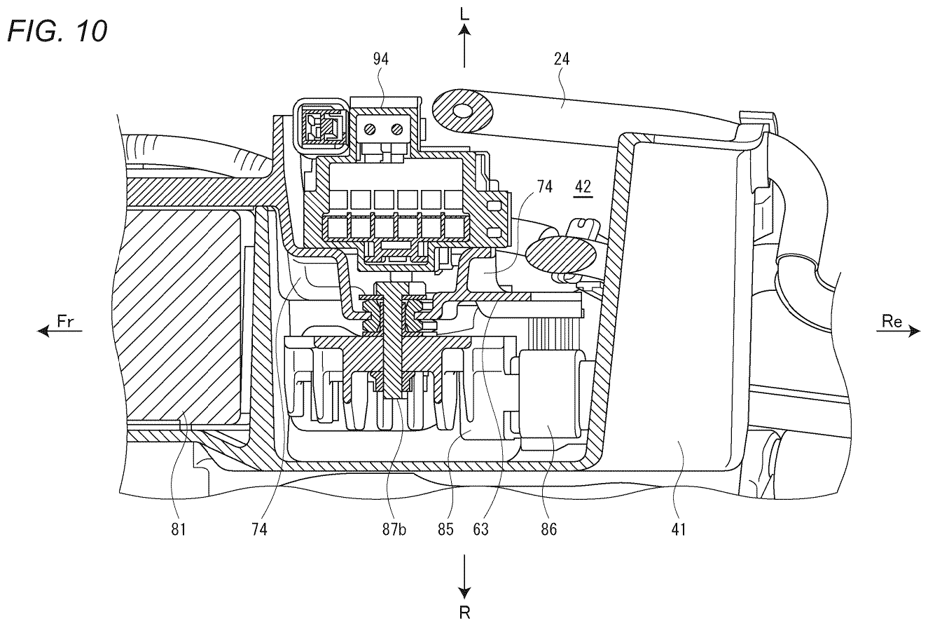

Hereinafter, a layout of the battery and the electrical components will be described with reference to FIGS. 3, 6, and 10. FIG. 6 is a sectional view of the parts box in FIG. 2 taken along a line A-A. FIG. 7 is a sectional view of the parts box in FIG. 2 taken along a line B-B. FIG. 8 is a sectional view of the parts box in FIG. 2 taken along a line C-C. FIG. 9 is a sectional view of the parts box in FIG. 3 taken along a line D-D. FIG. 10 is a sectional view of the parts box in FIG. 3 taken along a line E-E.

As illustrated in FIG. 6, the storage space 42 of the parts box 30 is partitioned by the battery holding portion 62 such that the inner side in the vehicle width direction is wider than the outer side in the vehicle width direction. The battery 81 is stored in the wide space on the inner side in the vehicle width direction, and the maintenance notebook 96 is stored in the narrow space on the outer side in the vehicle width direction. That is, the maintenance notebook 96 is stored on the lateral side of the battery 81 with the battery holding portion 62 interposed therebetween. Although the wider the battery 81, the narrower the space on the outer side in the vehicle width direction, the maintenance notebook 96 is stored using the narrow space. In addition to or instead of the maintenance notebook, a thin article such as a manual may be stored in the narrow space.

The fixing portion 75a extends from a lower edge of the separator 61 (battery holding portion 62), and a protrusion 33 of the parts cover 32 is inserted into the rubber bush 76a of the fixing portion 75a. Since the fixing portion 75a is provided on the separator 61, the fixing portion 75a is sufficiently separated from a side wall 47 of the parts holder 41 in the vehicle width direction. A routing path of linear members such as the main harness 99 and the purge hose 24 is secured between the fixing portion 75a of the separator 61 and the parts holder 41. The frame cover 31 is located at the outer side of the separator 61 in the vehicle width direction, and the frame cover 31 is attached to the seat frame 28 and the parts cover 32.

As illustrated in FIG. 7, the storage space 42 of the parts box 30 is partitioned by the parts holding portion 63 such that the inner side in the vehicle width direction is wider than the outer side in the vehicle width direction. The rectifier 85 is stored in the narrow space on the inner side in the vehicle width direction, and the starter motor relay 91 and the fuse box 94 are stored in the wide space on the outer side in the vehicle width direction. The rectifier 85 is stored in a vertical posture, and a width dimension of the rectifier 85 is directed in the vehicle width direction. The rectifier 85 having a relatively small width and the starter motor relay 91 and the fuse box 94 having a relatively large width are compactly stored in the rear space of the battery 81.

The rectifier 85 is stored on the inner side in the vehicle width direction similar as the battery 81 (see FIG. 6), and a heavy object is located on the inner side in the vehicle width direction, so that the steering stability of the vehicle is not impaired. Further, the starter motor relay 91 is held at an upper half of the parts holding portion 63, and the fuse box 94 is held at a lower half of the parts holding portion 63. Since the relay terminal 92 (see FIG. 5) of the starter motor relay 91 is located on the rear side of the pair of battery terminals 82 (see FIG. 5) of the battery 81, a distance from the battery terminals 82 to the starter motor relay 91 is reduced, and the lead wire 98 (see FIG. 3) can be shortened.

As illustrated in FIG. 8, an upper portion of the parts holding portion 63 is fixed to the parts holder 41, and a lower portion of the parts holding portion 63 is spaced apart from the parts holder 41. That is, the lower portion of the parts holding portion 63 is not fixed to the parts holder 41. The parts holding portion 63 is formed to be thin and easily bent without a rib such as the battery holding portion 62 (see FIG. 5). Even when the parts box 30 is pushed inward in the vehicle width direction due to a rollover of the vehicle or the like, the impact on the rectifier 85, the starter motor relay 91, and the fuse box 94 is reduced by bending the parts holding portion 63 inward in the vehicle width direction with a fixed position as a fulcrum.

As illustrated in FIGS. 3 and 9, an upper half of the rectifier 85 is fastened and fixed to an inner side surface of the upper half of the parts holding portion 63 by a bolt 87a. A pair of upper and lower protrusions 73 protrude from an outer side surface of the upper half of the parts holding portion 63, and the starter motor relay 91 is fixed while at least a part of the starter motor relay 91 is inserted between the pair of upper and lower protrusions 73. A fastening position of the bolt 87a is located between the pair of upper and lower protrusions 73, and the upper half of the rectifier 85 and the starter motor relay 91 are aligned in the vehicle width direction with the parts holding portion 63 interposed therebetween. The rectifier 85 and the starter motor relay 91 overlap with each other in the side view, and are compactly stored on an upper rear side of the storage space 42.

As illustrated in FIGS. 3 and 10, a lower half of the rectifier 85 is fastened and fixed to an inner side surface of the lower half of the parts holding portion 63 by a bolt 87b. The pair of front and rear protrusions 74 protrude from an outer side surface of the lower half of the parts holding portion 63, and the fuse box 94 is fixed while at least a part of the fuse box 94 is inserted between the pair of front and rear protrusions 74. A fastening position of the bolt 87b is located between the pair of front and rear protrusions 74, and the lower half of the rectifier 85 and the fuse box 94 are aligned in the vehicle width direction with the parts holding portion 63 interposed therebetween. The rectifier 85 and the fuse box 94 overlap with each other in the side view, and are compactly stored on a lower rear side of the storage space 42.

In this manner, the battery 81 and the rectifier 85 are aligned in the front-rear direction, and the maintenance notebook 96, the starter motor relay 91, and the fuse box 94 are aligned in the front-rear direction. The battery 81 and the maintenance notebook 96 are aligned in the vehicle width direction, and the rectifier 85, the starter motor relay 91, and the fuse box 94 are aligned in the vehicle width direction. The starter motor relay 91 and the fuse box 94 are aligned in the upper-lower direction. The battery 81, the maintenance notebook 96, and the plurality of electrical components are compactly stored inside the parts box 30 in the front-rear direction, the vehicle width direction, and the upper-lower direction, thereby reducing the size of the parts box 30.

As illustrated in FIG. 3, the canister 22 is installed on the rear side of the parts box 30. The surge hose 23 extends from the canister 22 toward the fuel tank 18 (see FIG. 1), and the purge hose 24 extends from the canister 22 toward an air intake component. The surge hose 23 and some wiring extend forward above the parts holder 41, and the purge hose 24 and the main harness 99 extend forward below the separator 61 inside the parts holder 41. Since a routing path of the purge hose 24 is secured in the storage space 42 of the parts holder 41, the purge hose 24 can be safely routed without being conspicuous even when the canister 22 is installed in the vehicle.

As described above, with the parts box 30 according to the present embodiment, the storage space 42 is partitioned into the inner side and the outer side in the vehicle width direction by the separator 61, the battery 81 and the maintenance notebook 96 are stored on both sides of the battery holding portion 62 of the separator 61 in the vehicle width direction, and the rectifier 85, the starter motor relay 91, and the fuse box 94 are stored on both sides of the parts holding portion 63 of the separator in the vehicle width direction. The battery 81, the maintenance notebook 96, the rectifier 85, the starter motor relay 91, and the fuse box 94 are compactly stored separately in the front, rear, left, and right directions. The parts box 30 can be reduced in size and deterioration of the appearance of the vehicle can be suppressed.

In the present embodiment, the plurality of electrical components are a rectifier, a starter motor relay, and a fuse box, but the types of the plurality of electrical components are not particularly limited

In the present embodiment, the vehicle body cover is implemented by the frame cover and the parts cover, but the vehicle body cover may be implemented by a single member or may be implemented by three or more members.

In the present embodiment, the battery is held on the inner side surface of the battery holding portion of the separator, but the battery may be held on the outer side surface of the battery holding portion. In this case, the parts holding portion may be located at the outer side in the vehicle width direction with respect to the battery holding portion.

In the present embodiment, the rectifier is held on the inner side surface of the parts holding portion, and the starter motor relay and the fuse box are held on the outer side surface of the parts holding portion, but the starter motor relay and the fuse box may be held on the inner side surface of the parts holding portion, and the rectifier may be held on the outer side surface of the parts holding portion.

In the present embodiment, the rectifier is fastened and fixed to the parts holding portion, but a method of holding the rectifier is not particularly limited. The rectifier may be inserted into and fixed to the parts holding portion.

In the present embodiment, the starter motor relay and the fuse box are inserted and fixed to the parts holding portion, but a method of holding the starter motor relay and the fuse box is not particularly limited. The starter motor relay and the fuse box may be fastened and fixed to the parts holding portion.

The parts box according to the present embodiment is not limited to the above-described straddle-type vehicle and may be adopted in other straddle-type vehicles. The straddle-type vehicle is not limited to a general vehicle in which a driver rides on a seat in a posture of straddling the seat, and includes a scooter-type vehicle in which the driver rides on the seat without straddling the seat.

In a first aspect, there is provided a parts box (30) of a straddle-type vehicle (1) configured to store a battery (81) and a plurality of electrical components, the parts box (30) including: a parts holder (41) having a storage space (42) opened on an outer side in a vehicle width direction; a vehicle body cover (frame cover 31, parts cover 32) configured to cover an opening of the storage space from the outer side in the vehicle width direction; and a separator (61) configured to partition the storage space into an inner side and the outer side in the vehicle width direction, in which: the separator includes: a battery holding portion (62) configured to hold the battery: and a parts holding portion (63) including a first side surface and a second side surface opposite to the first side surface in the vehicle width direction, the parts holding portion being configured to hold the plurality of electrical components; and the plurality of electrical components include: a first electrical component held on the first side surface of the parts holding portion; and a second electrical component held on the second side surface of the parts holding portion. With this configuration, the separator is divided into the battery holding portion and the parts holding portion to hold the battery and the plurality of electrical components, and the battery and the plurality of electrical components are separately stored at the inner side and the outer side of the storage space of the parts box. Therefore, the battery and the plurality of electrical components are compactly stored in the parts box, so that the parts box can be reduced in size and deterioration of the appearance of the vehicle can be suppressed.

In a second aspect, there is provided the parts box according to the first aspect, in which: the battery is held on one side surface of the battery holding portion in the vehicle width direction; and the parts holding portion is located on the rear side of the battery holding portion, and the parts holding portion is located on a battery side relative to the battery holding portion in the vehicle width direction. With this configuration, the plurality of electrical components can be compactly stored using the rear space of the battery, which is wide.

In a third aspect, there is provided the parts box according to the first or second aspect, in which: a fixing portion (75a) extends from a lower edge of the separator, and a part (protrusion 33) of the vehicle body cover is fixed to the fixing portion; and a routing path of a linear member (main harness 99, purge hose 24) is secured between the fixing portion of the separator and the parts holder. With this configuration, the linear member can be routed in the storage space of the parts box.

In a fourth aspect, there is provided the parts box according to any one of the first to third aspects, in which an upper portion of the parts holding portion is fixed to the parts holder, and a lower portion of the parts holding portion is spaced apart from the parts holder. With this configuration, even when the parts box is pushed inward in the vehicle width direction due to a rollover of the vehicle or the like, the parts holding portion bends inward in the vehicle width direction with a fixed position as a fulcrum, so that the impact on the plurality of electrical components can be alleviated.

In a fifth aspect, there is provided the parts box according to any one of the first to fourth aspects, in which the first electrical component is fastened and fixed to a fastening position of the first side surface of the parts holding portion, the second electrical component is fixed while at least a part of the second electrical component is inserted between a pair of protrusions protruding from the second side surface of the parts holding portion, and the fastening position is located between the pair of protrusions. With this configuration, the first electrical component and the second electrical component overlap with each other in the vehicle width direction with the parts holding portion interposed therebetween, and the first electrical component and the second electrical component can be compactly stored to reduce the size of the parts box.

In a sixth aspect, there is provided the parts box according to the second aspect, in which: the plurality of electrical components include a rectifier (85), a starter motor relay (91), and a fuse box (94); and the rectifier is stored on one side of the parts holding portion in the vehicle width direction, and the starter motor relay and the fuse box are stored on another side of the parts holding portion in the vehicle width direction. With this configuration, since the parts holding portion is located on a battery side relative to the battery holding portion in the vehicle width direction, a space on one side of the parts holding portion in the vehicle width direction is narrower than a space on the other side in the vehicle width direction. Therefore, the rectifier with a relatively thin width is stored on one side of the parts holding portion, in the vehicle width direction and the starter motor relay and the fuse box with a relatively large width are stored in the other side of the parts holding portion in the vehicle width direction, so that the rectifier, the starter motor relay, and the fuse box can be compactly stored by using the rear space of the battery.

In a seventh aspect, there is provided the parts box according to a sixth aspect, in which: an upper portion of the battery is provided with a battery terminal (82); and the starter motor relay is held at an upper half of the parts holding portion, and the fuse box is held at a lower half of the parts holding portion. With this configuration, the starter motor relay is located on the rear side of the battery terminal, so that a distance from the battery terminal to the starter motor relay is reduced, and the lead wire can be shortened.

In an eighth aspect, there is provided the parts box according to any one of the first to seventh aspects, in which at least one of a manual and a notebook (maintenance notebook 96) is stored on a lateral side of the battery with the battery holding portion interposed therebetween. With this configuration, the manual and/or the notebook can be stored using a narrow space on the lateral side of the battery.

In a ninth aspect, there is provided the parts box according to the sixth aspect, in which the battery is stored at the inner side in the vehicle width direction with respect to the battery holding portion, the rectifier is stored at the inner side in the vehicle width direction with respect to the parts holding portion, and the starter motor relay and the fuse box are stored at the outer side in the vehicle width direction with respect to the parts holding portion. With this configuration, even when the battery and the plurality of electrical components are stored in the parts box, a heavy object is located at the inner side in the vehicle width direction, so that the steering stability of the vehicle is not impaired.

In a tenth aspect, there is provided the parts box according to any one of the first to ninth aspects, in which a routing path of a hose (purge hose 24) for a canister (22) is secured in the storage space. With this configuration, even when the canister is installed in the vehicle, the hose for the canister can be safely routed without being conspicuous.

Although the present embodiment is described, a part or all of the above-described embodiment and modifications may be combined as another embodiment.

The technique according to the present disclosure is not limited to the above-described embodiment, and may be variously changed, replaced, or modified without departing from the gist of the technical concept. Further, the present disclosure may be implemented by other methods as long as the technical concept can be implemented by the methods through advance of the technique or other derivative techniques. Therefore, the claims cover all embodiments that may fall within the scope of the technical concept.

What is claimed is:

1. A parts box of a straddle-type vehicle configured to store a battery and a plurality of electrical components, the parts box comprising:
a parts holder having a storage space opened on an outer side in a vehicle width direction;
a vehicle body cover configured to cover an opening of the storage space from the outer side in the vehicle width direction; and
a separator configured to partition the storage space into an inner side and the outer side in the vehicle width direction,
wherein the separator comprises: a battery holding portion configured to hold the battery; and a parts holding portion comprising a first side surface and a second side surface opposite to the first side surface in the vehicle width direction, the parts holding portion being configured to hold the plurality of electrical components, and
wherein the plurality of electrical components comprise: a first electrical component held on the first side surface of the parts holding portion; and a second electrical component held on the second side surface of the parts holding portion.

2. The parts box according to claim 1,
wherein the battery is held on one side surface of the battery holding portion in the vehicle width direction, and
wherein the parts holding portion is located on a rear side of the battery holding portion, and the parts holding portion is located on a battery side relative to the battery holding portion in the vehicle width direction.

3. The parts box according to claim 1,
wherein a fixing portion extends from a lower edge of the separator, and a part of the vehicle body cover is fixed to the fixing portion, and
wherein a routing path of a linear member is secured between the fixing portion of the separator and the parts holder.

4. The parts box according to claim 1,
wherein an upper portion of the parts holding portion is fixed to the parts holder, and a lower portion of the parts holding portion is spaced apart from the parts holder.

5. The parts box according to claim 1,
the first electrical component is fastened and fixed to a fastening position of the first side surface of the parts holding portion, the second electrical component is fixed while at least a part of the second electrical component is inserted between a pair of protrusions protruding from the second side surface of the parts holding portion, and the fastening position is located between the pair of protrusions.

6. The parts box according to claim 2,
wherein the plurality of electrical components comprise a rectifier, a starter motor relay, and a fuse box, and
wherein the rectifier is stored on one side of the parts holding portion in the vehicle width direction, and the starter motor relay and the fuse box are stored on another side of the parts holding portion in the vehicle width direction.

7. The parts box according to claim 6,
wherein an upper portion of the battery is provided with a battery terminal, and
wherein the starter motor relay is held at an upper half of the parts holding portion, and the fuse box is held at a lower half of the parts holding portion.

8. The parts box according to claim 1,
wherein at least one of a manual and a notebook is stored on a lateral side of the battery with the battery holding portion interposed therebetween.

9. The parts box according to claim 6,
wherein the battery is stored at the inner side in the vehicle width direction with respect to the battery holding portion, the rectifier is stored at the inner side in the vehicle width direction with respect to the parts holding portion, and the starter motor relay and the fuse box are stored at the outer side in the vehicle width direction with respect to the parts holding portion.

10. The parts box according to claim 1,
wherein a routing path of a hose for a canister is secured in the storage space.
